(19) United States
(12) Patent Application Publication
(10) Pub. No.: US 2001/0016558 A1
(43) Pub. Date: Aug. 23, 2001

(54) Thermal transfer sheet for transferring protective layer

(75) Inventors: Kimihiro Yagi, Osaka-fu (JP); Masahiro Aoki, Osaka-fu (JP); Yukiko Tsujita, Osaka-fu (JP)

Correspondence Address: FISH & NEAVE, 1251 AVENUE OF THE AMERICAS, 50TH FLOOR, NEW YORK, NY, 10020-1105, US

(73) Assignee: Fujicopian Co., Ltd.

(21) Appl. No.: 09/775,296

(22) Filed: Jan. 31, 2001

(30) Foreign Application Priority Data
Feb. 4, 2000 (JP) 27994/2000

(51) Int. Cl. B41M 5/035

(52) U.S. Cl. 503/227

(57) ABSTRACT

A thermal transfer sheet for transferring a protective layer on an image formed on a receiving body by a thermal transfer method, comprising a substrate and a thermally transferable protective layer provided on the substrate, the protective layer comprising an inorganic stratified compound component and a binder component, the inorganic stratified compound component being contained in an amount of 3 to 150 parts by weight relative to 100 parts by weight of the binder component, wherein the inorganic stratified compound component comprises 2 or more groups of laminas of at least one inorganic stratified compound, the respective groups having different average particle sizes with each other.

### BACKGROUND OF THE INVENTION

The present invention belongs to an overprinting technology which improves the scratch resistance and the like of an image transferred on a receiving body in a thermal transfer recording field.

There is known a technology wherein a transparent protective layer comprising a wax and/or a resin, or a protective layer further containing particles therein is overprinted as an image protective layer on a color image formed on a receiving body by a thermal transfer method.

However, not only in the case of the transparent protective layer comprising a wax/or a resin but also in the case of the protective layer further containing particles therein, there is a problem that the scratch resistance is deteriorated due to fragility inherent to a wax or tackiness inherent to a resin and, therefore, a sufficient image protecting effect can not be exerted.

In view of the foregoing, it is an object of the present invention to provide a thermal transfer sheet for transferring a protective layer in which the scratch resistance of the protective layer which was insufficient in the prior art is improved, thereby exerting a satisfactory protection of an image formed on a receiving body by a thermal transfer method.

This and other objects of the present invention will become apparent from the description hereinafter.

### SUMMARY OF THE INVENTION

According to the present invention, an inorganic stratified compound is added to a protective layer of a thermal transfer sheet in order to substantially improve the scratch resistance of an image formed on a receiving body by a thermal transfer method. Thus the present invention has succeeded in a rapid improvement on an image protecting performance.

That is, the present invention provides (1) a thermal transfer sheet for transferring a protective layer on an image formed on a receiving body by a thermal transfer method, comprising a substrate and a thermally transferable protective layer provided on the substrate, the protective layer comprising an inorganic stratified compound component and a binder component, the inorganic stratified compound component being contained in an amount of 3 to 150 parts by weight relative to 100 parts by weight of the binder component,

wherein the inorganic stratified compound component comprises 2 or more groups of laminas of at least one inorganic stratified compound, the respective groups having different average particle sizes with each other.

Further, the present invention provides (2) the thermal transfer sheet of the above (1), wherein the 2 or more groups of laminas having different average particle sizes comprises (A) 60 to 95% by weight, on the basis of the total amount of the inorganic stratified compound component, of one or more groups of laminas having an average particle size of not smaller than 0.5 μm and less than 5 μm and (B) 5 to 40% by weight, on the basis of the total amount of the inorganic stratified compound component, of one or more groups of laminas having an average particle size of not smaller than 5 μm and not greater than 25 μm.

Further, the present invention provides (3) the thermal transfer sheet of the above (2), wherein the 2 or more groups of laminas having different average particle sizes have a difference of 5 μm or more in average particle size between the groups, and show a particle size distribution curve having a plurality of peaks.

Further, the present invention provides (4) the thermal transfer sheet of the above (1), wherein the binder component comprises a wax as a main component by weight.

Further, the present invention provides (5) the thermal transfer sheet of the above (1), wherein the protective layer has a thickness of 0.5 to 6 μm.

Further, the present invention provides (6) a method of protecting an image, comprising the steps of:

providing a thermal transfer sheet comprising a substrate and a thermally transferable protective layer provided on the substrate, the protective layer comprising an inorganic stratified compound component and a binder component, the inorganic stratified compound component being contained in an amount of 3 to 150 parts by weight relative to 100 parts by weight of the binder component,

wherein the inorganic stratified compound component comprises 2 or more groups of laminas of at least one inorganic stratified compound, the respective groups having different average particle sizes with each other, and

thermally transferring the protective layer of the thermal transfer sheet onto an image formed on a receiving body by a thermal transfer method.

### BRIEF DESCRIPTION OF THE DRAWING

FIG. 1 is a schematic partial cross-sectional view showing an example of a thermal transfer sheet according to the present invention.

### DETAILED DESCRIPTION

The present invention will be explained in detail below.

A protective layer in the thermal transfer sheet of the present invention contains an inorganic stratified compound (or inorganic layered compound) and a binder as an essential component. The binder comprises a wax and/or a resin. The inorganic stratified compound material is cleaved to form laminas in the binder, and the resulting laminas are highly densely finely-dispersed in a plate state randomly piece by piece and in parallel with a coating surface of the protective layer. Fine dispersion of laminas of the inorganic stratified compound in this form in the protective layer exerts an extremely tough retaining force against the destruction of the protective layer due to stress from the outside, as compared with a protective layer comprising a wax or a resin without inclusion of an inorganic stratified compound or a protective layer in which spherical or irregular particles such as silica particles are dispersed. As a result, a protective layer having a satisfactory scratch resistance can be obtained.

As a substrate of the thermal transfer sheet of the present invention, plastic films such as polyester films having a thickness of 2.5 to 6 μm are particularly preferable. It is preferable that a stick preventing layer is provided on a back of the substrate. A protective layer which is an essential feature of the present invention is provided on the substrate.

Examples of binders for the protective layer are not limited to but include waxes such as paraffin wax, carnauba wax, candelilla wax, montan wax, polyethylene wax and maleic acid-modified wax; and resins such as olefin resins and modified olefin resins including ethylene polymers and propylene polymers, and copolymers thereof, and vinylidene chloride resin, styrene resin, (meth)acrylic ester polymers and copolymers thereof, acetal resins such as polyvinyl butyral, and cellulose derivatives. These waxes or resins may be used as a mixture of 2 or more species thereof. In the present invention, a binder component comprising a wax as a main component by weight is preferably used to impart an excellent melt-transfer performance to the protective layer.

As the inorganic stratified compound, talc, montmorillonite, zirconium phosphate, taeniolite, saponite, hectolite, zeolite, titanates (K₂Ti₄O₉), niobates (K₄Nb₆O₁₇), graphite, sulfides (MoS₂), mica such as muscovite, paragonite and lepidolite, and, further, synthetic smectites, and expandable or non-expandable synthetic mica such as fluorine-containing synthetic mica and silicon-containing synthetic mica, and the like can be used. When a particle size of an inorganic stratified compound in a protective layer is too small, the protecting function is tends to be decreased, resulting in a decrease in scratch resistance. On the other hand, the particle size is too large, a surface flatness of a protective layer after being thermally transferred tends to be decreased, resulting in loss of glossiness. From these points, an inorganic stratified compound having an average particle size of 0.5 to 25 μm in a protective layer is preferable. Herein, the average particle size of an inorganic stratified compound refers to a value measured by a laser light scattering method.

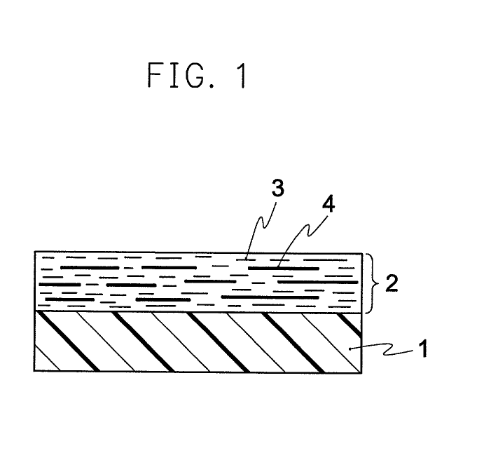

In the present invention, from the standpoint of protecting performance, the inorganic stratified compound component in the protective layer comprises 2 or more groups of laminas of at least one inorganic stratified compound, the respective groups having different average particle sizes with each other. Herein, the term “lamina” refers to a minute particle in a flat plate form. In the present invention, particles obtained by cleavage of an inorganic stratified compound material refer to laminas. FIG. 1 is a schematic partial sectional view showing an example of a thermal transfer sheet according to the present invention. In FIGURE, 1 denotes a substrate, and a protective layer 2 is provided on the substrate 1. A group of laminas 3 and another group of laminas 4 of an inorganic stratified compound(s), which both groups have different average particle sizes with each other, are dispersed in the protective layer 2. The laminas of group 3 have a small average particle size and the laminas of group 4 have a large average particle size. The reason why the protecting performance is particularly satisfactory in this embodiment is not clear but it is considered that when laminas 3 and laminas 4 having different average particle sizes with each other are present in a mixture, these laminas are aligned densely in a plane direction of a protective layer as compared with the use of laminas having a single average particle size alone, as shown is FIG. 1. Thereby, the function of protecting image is much improved.

In the aforementioned embodiment, it is more preferable that the aforementioned 2 or more groups of laminas having different average particle sizes comprises (A) 60 to 95% by weight, on the basis of the total amount of the inorganic stratified compound component, of laminas having an average particle size of not smaller than 0.5 μm and less than 5 μm and (B) 5 to 40% by weight, on the basis of the total amount of the inorganic stratified compound component, of laminas having an average particle size of not smaller than 5 μm and not greater than 25 μm. The laminas (A) may comprises 2 or more groups of laminas having different average particle sizes with each other within the range of not smaller than 0.5 μm and less than 5 μm. The laminas (B) may comprises 2 or more groups of laminas having different average particle sizes with each other within the range of not smaller than 0.5 μm and less than 5 μm. When a proportion of the laminas (B) having an average particle size of not smaller than 5 μm and not greater than 25 μm exceeds 40% by weight, thus the surface of a protective layer after thermally transferred tends to become uneven or irregular, causing disadvantages such as decrease in the image quality. On the other hand, when a proportion of the laminas (B) having an average particle size of not smaller than 5 μm and not greater than 25 μm is less than 5% by weight, there is a tendency that such an effect can not be obtained that inclusion of at least 2 groups of laminas having different average particle sizes in a protective layer leads to dense alignment of laminas.

In this embodiment, further, it is preferred that the 2 or more groups of laminas (A) and laminas (B) having different average particle sizes have a difference of 5 μm or more in average particle size between the groups, and show a particle size distribution curve having a plurality of peaks. For example, when the aforementioned laminas (A) having an average particle size of not smaller than 0.5 μm and less than 5 μm show a single peak in the particle size distribution curve and the aforementioned laminas (B) having an average particle size of not smaller than 5 μm and not greater than 25 μm show a single peak in the particle size distribution curve, it is preferable that a difference in average particle size between the laminas (A) and the laminas (B) is 5 μm or more. In addition, when the aforementioned laminas (B) having an average particle size of 5 μm or more and not greater than 25 μm comprises 2 groups of laminas having different average particle sizes, i.e., a group of laminas (B1) showing a single peak in the particle size distribution curve and having a smaller average particle size and another group of laminas (B2) showing a single peak in the particle size distribution curve and having a greater average particle size, it is preferable that a difference in average particle size between the laminas (A) and the laminas (B1) is 5 μm or more, and a difference in average particle size between the laminas (B1) and the laminas (B2) is 5 μm or more.

The inorganic stratified compound in a protective layer is preferably contained in an amount of 3 to 150 parts by weight, particularly 20 to 100 parts by weight relative to 100 parts of by weight of a binder. When a content of the inorganic stratified compound is below the above range, the improvement in the image protection due to inclusion of the inorganic stratified compound can not be manifested satisfactorily. On the other hand, when a content of the inorganic stratified compound exceeds the above range, a transfer failure tends to occur. When a thickness of a protective layer is less than 0.5 μm, the function of protecting image is decreased. When the thickness exceeds 6 μm, the transfer sensitivity tends to be decreased so that entire solid transfer tends to become difficult.

A fluorescent brightener, an ultraviolet-ray absorbing agent, a surfactant, or the like may be appropriately added to a protective layer if necessary in a range without deteriorating the object of the present invention.

It is desirable that a protective layer is substantially colorless and transparent so as not to change a color of an image. However, in order to change a tone of the whole of an image, a protective layer may be slightly colored. Known pigments, dyes or metal powders may be contained in a protective layer to color it.

The thermal transfer sheet of the present invention may have a construction in which only a protective layer is provided on a substrate, or a construction in which a colored ink layer together with a protective layer is provided on the same substrate. In the latter case, there is a construction in which a protective layer and colored ink layers of one or more colors (e.g., yellow ink layer, magenta ink layer and cyan ink layer) are successively arranged repeatedly in a side-by-side relation on the same substrate. When this thermal transfer sheet is used, colored ink layers of a plurality of different colors are successively transferred onto a receiving body by a thermal transfer method to form a multi- or full-color image, and thereafter a protective layer can be transferred onto the image in the same thermal transfer step. The colored ink layer is preferably a melt-transfer type or softening-transfer type transferable layer and comprises a coloring agent and a binder. As the coloring agent, known inorganic or organic pigments or dyes can be used. The binder comprises a wax and/or a resin. A melt-transfer type colored ink layer contains a binder comprising a wax as a main component by weight. A softening-transfer type colored ink layer contains a binder comprising a resin as a main component by weight.

The thermal transfer sheet of the present invention can be used for the protection of a print image formed by any of thermal transfer methods including a melt- or softening-transfer type transfer method and a sublimation-transfer type transfer method. However, the thermal transfer sheet of the present invention is preferably used for the protection of a print image formed by a melt- or softening-transfer type transfer method, particularly a melt-transfer type transfer method. A print image formed by a melt-transfer type transfer method involves a problem that it has a relatively low scratch resistance.

The present invention will be explained in more detail by way of Examples. It is to be understood that the present invention is not limited to these Examples, and various changes and modifications may be made in the invention without departing from the spirit and scope thereof.

### EXAMPLES 1 to 2 AND COMPARATIVE EXAMPLES 1 to 5

A protective layer ink having the following formulation was prepared, and the ink was applied at a coating thickness of 4 μm by a hot-melt method onto a polyethylene terephthalate film having a thickness of 4.5 μm with a stick preventing treatment on the back side thereof, yielding a thermal transfer sheet. In the following formulation, abbreviations mean as follows:

EVA: ethylene-vinyl acetate copolymer

VA: vinyl acetate

### COMPARATIVE EXAMPLE 1

| Component | % by weight |
|---|---|
| Inorganic stratified compound: synthetic | 25 |
| smectite (average particle size 3 μm) | |
| EVA (softening point 70° C., VA content 28% | 25 |
| by weight) | |
| Paraffin wax (melting point 70° C.) | 25 |
| α-Olefin-maleic anhydride copolymer wax | 23 |
| Dispersing agent | 2 |

### COMPARATIVE EXAMPLE 2

| Component | % by weight |
|---|---|
| Inorganic stratified compound: synthetic | 30 |
| smectite (average particle size 8 μm) | |
| EVA (softening point 70° C., VA content 28% | 10 |
| by weight) | |
| Paraffin wax (melting point 70° C.) | 35 |
| α-Olefin-maleic anhydride copolymer wax | 23 |
| Dispersing agent | 2 |

### COMPARATIVE EXAMPLE 3

| Component | % by weight |
|---|---|
| Inorganic stratified compound: synthetic | 30 |
| smectite (average particle size 15 μm) | |
| EVA (softening point 70° C., VA content 28% | 10 |
| by weight) | |
| Paraffin wax (melting point 70° C.) | 35 |
| α-Olefin-maleic anhydride copolymer wax | 23 |
| Dispersing agent | 2 |

### EXAMPLE 1

| Component | % by weight |
|---|---|
| Inorganic stratified compound: | |
| Synthetic smectite (average particle size 3 μm) | 25 |
| Synthetic smectite (average particle size 15 μm) | 5 |
| EVA (softening point 70° C., VA content 28% by weight) | 10 |
| Paraffin wax (melting point 70° C.) | 35 |
| α-Olefin-maleic anhydride copolymer wax | 23 |
| Dispersing agent | 2 |

### EXAMPLE 2

| Component | % by weight |
|---|---|
| Inorganic stratified compound: | |
| Synthetic smectite (average particle size 3 μm) | 20 |
| Synthetic smectite (average particle size 8 μm) | 7 |
| Synthetic smectite (average particle size 15 μm) | 3 |
| EVA (softening point 70° C., VA content 28% by weight) | 10 |
| Paraffin wax (melting point 70° C.) | 35 |
| α-Olefin-maleic anhydride copolymer wax | 23 |
| Dispersing agent | 2 |

### COMPARATIVE EXAMPLE 4

| Component | % by weight |
|---|---|
| Silica particles (average particle size 5 μm) | 20 |
| EVA (softening point 70° C., VA content 28% | 25 |
| by weight) | |
| Paraffin wax (melting point 70° C.) | 35 |
| α-Olefin-maleic anhydride copolymer wax | 20 |

### COMPARATIVE EXAMPLE 5

| Component | % by weight |
|---|---|
| EVA (softening point 70° C., VA content 28% | 40 |
| by weight) | |
| Paraffin wax (melting point 70° C.) | 60 |

A color image was formed on the following receiving paper by means of the following thermal transfer printer using a color ink ribbon exclusively used for the printer, and then a protective layer was transferred onto the color image by the same thermal transfer printer using each of the thermal transfer sheets obtained above and assessment of the protecting performance was conducted by the following assessing method.

Printing Condition

Printer: Color Point 1635 manufactured by Seiko Instruments Inc.

Receiving paper: a paper sheet (CH-896) exclusively used for the aforementioned printer

Method for Assessment

A stress resistance test (tester: Crock meter) was conducted in which a cotton cloth was reciprocated 50 times on a color image with each protective layer transferred thereon at a load of 500 g/cm², a degree of damage of the color image was observed by the naked eye, and the image protecting effects by each protective layer were evaluated by the following criteria. The results are shown in Table 1.

TABLE 1

| | Number of reciprocation of cotton cloth (times) | | | |
|---|---|---|---|---|
| | 5 | 15 | 30 | 50 |
| Com. Ex. 1 | ◯ | ◯ | ◯ | X |
| Com. Ex. 2 | ◯ | ◯ | ◯ | Δ |
| Com. Ex. 3 | ◯ | ◯ | ◯ | Δ |
| Ex. 1 | ◯ | ◯ | ◯ | ◯ |
| Ex. 2 | ◯ | ◯ | ◯ | ◯ |
| Com. Ex. 4 | ◯ | Δ | X | X |
| Com. Ex. 5 | ◯ | X | X | X |

: No damage in the image
Δ: Slight damage in the image
X: Remarkable damage in the image

As shown in Table 1, in Examples 1 and 2 wherein a protective layer containing 2 or 3 groups of laminas of a synthetic smectite having different average particle sizes was used, no damage was observed in the color image even by rubbing 50 times with a cotton cloth. On the other hand, in Comparative Examples 1 to 3 wherein a protective layer containing laminas of a synthetic smectite having a single average particle size was used, damage was observed in the color image by rubbing 50 times. In Comparative Example 4 wherein a protective layer containing silica particles was used, damage in the image was initiated by rubbing about 15 times. In Comparative Example 5 wherein a protective layer containing no particles was used, damage in the image was initiated by rubbing about 10 times.

In addition to the materials and ingredients used in the Examples, other materials and ingredients can be used in the Examples as set forth in the specification to obtain substantially the same results.

The thermal transfer sheet of the present invention can provide a satisfactory protection to a surface of an image by a thermal transfer method.

What is claimed is:

1. A thermal transfer sheet for transferring a protective layer on an image formed on a receiving body by a thermal transfer method, comprising a substrate and a thermally transferable protective layer provided on the substrate, the protective layer comprising an inorganic stratified compound component and a binder component, the inorganic stratified compound component being contained in an amount of 3 to 150 parts by weight relative to 100 parts by weight of the binder component,
wherein the inorganic stratified compound component comprises 2 or more groups of laminas of at least one inorganic stratified compound, the respective groups having different average particle sizes with each other.

2. The thermal transfer sheet of claim 1, wherein the 2 or more groups of laminas having different average particle sizes comprises (A) 60 to 95% by weight, on the basis of the total amount of the inorganic stratified compound component, of one or more groups of laminas having an average particle size of not smaller than 0.5 μm and less than 5 μm and (B) 5 to 40% by weight, on the basis of the total amount of the inorganic stratified compound component, of one or more groups of laminas having an average particle size of not smaller than 5 μm and not greater than 25 μm.

3. The thermal transfer sheet of claim 2, wherein the 2 or more groups of laminas having different average particle sizes have a difference of 5 μm or more in average particle size between the groups, and show a particle size distribution curve having a plurality of peaks.

4. The thermal transfer sheet of claim 1, wherein the binder component comprises a wax as a main component by weight.

5. The thermal transfer sheet of claim 1, wherein the protective layer has a thickness of 0.5 to 6 μm.

6. A method of protecting an image, comprising the steps of:
providing a thermal transfer sheet comprising a substrate and a thermally transferable protective layer provided on the substrate, the protective layer comprising an inorganic stratified compound component and a binder component, the inorganic stratified compound component being contained in an amount of 3 to 150 parts by weight relative to 100 parts by weight of the binder component,
wherein the inorganic stratified compound component comprises 2 or more groups of laminas of at least one inorganic stratified compound, the respective groups having different average particle sizes with each other, and
thermally transferring the protective layer of the thermal transfer sheet onto an image formed on a receiving body by a thermal transfer method.
